(19) United States
(12) Patent Application Publication
(10) Pub. No.: US 2008/0134914 A1
(43) Pub. Date: Jun. 12, 2008

(54) PRINTING PLATE AND RUBBER BLANKET PLATE FOR A PRINTING MACHINE

(75) Inventors: Thomas BOECK, Neusaess (DE); Norbert Dylla, Stadtbergen (DE); Josef Hammer, Plauen (DE); Wolfgang Kaeser, Mertingen (DE); Guenter Koppelkamm, Neuensalz (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/924,401

(22) Filed: Oct. 25, 2007

(30) Foreign Application Priority Data
Oct. 28, 2006 (DE) 10 2006 050 908.0

(51) Int. Cl. B41F 13/10

(52) U.S. Cl. 101/375; 101/376

(57) ABSTRACT

A printing plate for a printing machine, more preferably for a reel-fed rotary printing machine, is disclosed. The plate has a plate-like main body serving as a subject carrier, with a leading end which is angled-off relative to the main body, and with a trailing end which is angled-off relative to the main body where the printing plate can be mounted or placed on a form cylinder of a printing machine via the leading end and the trailing end, and where the leading end and the trailing end are symmetrically angled-off relative to the main body such that the leading end and the trailing end enclose an approximately identical angle with one side of the main body. The leading end and the trailing end each enclose an angle between 85° and 90° with the side of the main body.

This application claims the priority of German Patent Document No. 10 2006 050 908.0, filed Oct. 28, 2006, the disclosure of which is expressly incorporated by reference herein.

### BACKGROUND AND SUMMARY OF THE INVENTION

The invention relates to a printing plate for a printing machine. In addition the invention relates to a rubber blanket plate for a printing machine.

Printing mechanisms of printing machines have a form cylinder and a transfer cylinder, wherein at least one printing form is arranged on a form cylinder and at least one transfer form is arranged on a transfer cylinder. Printing forms are usually embodied as printing plates and transfer forms as rubber blanket plates, which is why a form cylinder is also called plate cylinder and a transfer cylinder is also called rubber cylinder. Printing plates and rubber blanket plates are mounted or stretched on the respective cylinder of a printing mechanism of a printing machine wherein for this purpose the printing plates and rubber blanket plates have leading ends and trailing ends which are angled-off relative to a plate-shaped main body of these. If for instance a printing plate is to be mounted on a form cylinder the leading end and the trailing end of the printing plate are inserted in at least one mounting channel of the form cylinder and clamped in the respective mounting channel by way of a clamping device integrated in the mounting channel.

From U.S. Pat. No. 4,727,807 it is already known to change printing plates on a form cylinder of a printing machine in an automated manner, wherein according to this prior art the printing plates used for this purpose are designed such that the leading end and the trailing end of a printing plate are symmetrically angled-off relative to the plate-shaped main body of the printing plate so that the leading end and the trailing end with one side of the main body enclose an approximately identical angle.

Here, the leading end and the trailing end are angled-off such that the leading end and trailing end enclose a relatively acute angle with the main body each of which is smaller than 45°. With such an acute angle there is the risk that if a mounted printing plate is to be changed and clamping devices interacting with the leading end and the trailing end are released for this purpose, the leading end and the trailing end jam in the mounting channel and then have to be manually freed from the mounting channel. This impairs automatic changing of the printing plate and has to be avoided. The same problem also occurs when rubber blanket plates are to be changed in an automated manner.

Starting from this the present invention is based on the problem of creating a new kind of printing plate and a new kind of rubber blanket plate for a printing machine.

According to the invention the leading end and the trailing end each enclose an angle between 85° and 90° with the side of the main body.

According to the invention both the leading end and the trailing end enclose a defined angle between 85° and 90° with one side of the main body. In this way it is avoided that the leading end and the trailing end jam in the mounting channel during automated plate changing. On the contrary, with such an angle the leading end and the trailing end of a printing plate spontaneously jump out of the respective mounting channel so that no manual intervention for freeing the leading end and trailing end from the corresponding mounting channel is required.

Preferentially the leading end and the trailing end have approximately identical leg lengths, namely leg lengths between 3 mm and 12 mm.

Preferred further developments of the invention are obtained from the following description. Exemplary embodiments of the invention are explained in more detail by means of the drawings without being restricted to these.

### BRIEF DESCRIPTION OF THE DRAWINGS

FIG. 1 is a schematised view of a printing plate according to the invention;

FIG. 2 is a schematised view of a printing unit of a reel-fed rotary printing machine together with printing plates according to the invention; and

FIG. 3 is a schematised view of a further printing unit of a reel-fed rotary printing machine together with printing plates according to the invention.

### DETAILED DESCRIPTION OF THE DRAWINGS

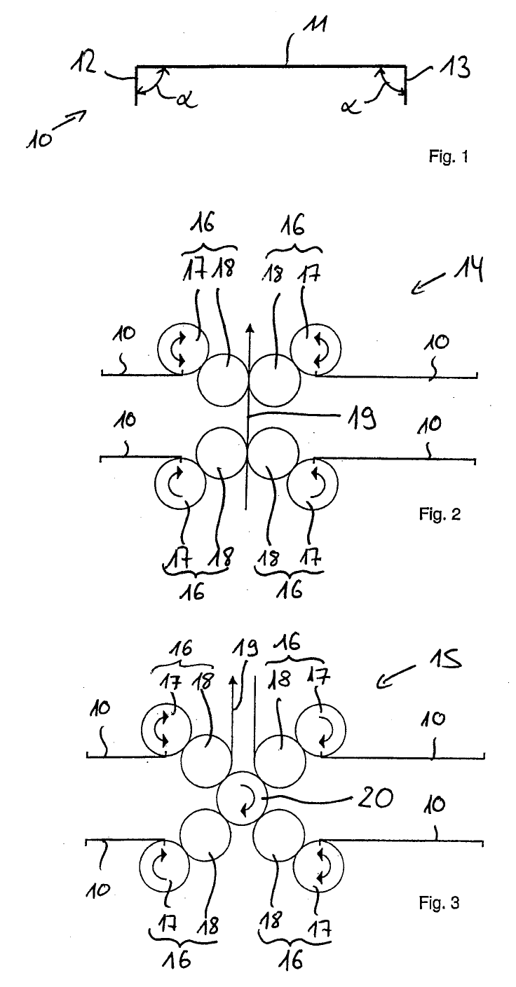

FIG. 1 shows, highly schematised, a printing plate 10 according to the invention, wherein the printing plate 10 has a plate-like main body 11 which serves as subject carrier or print image carrier. On opposite ends the printing plate 10 has sections which are angled-off relative to the main body 11, namely a so-called leading end 12 and a so-called trailing end 13. Via the leading end 12 and the trailing end 13 the printing plate 10 can be mounted or placed on a form cylinder, wherein for this purpose the form cylinder comprises at least one mounting channel with a clamping device integrated in the respective mounting channel.

According to FIG. 1 the leading end 12 and the trailing end 13 are angled-off symmetrically relative to the main body 11 namely such that the leading end 12 and the trailing end 13 enclose an approximately identical angle α with one side of the main body 11. Here the angle α amounts to between 85° and 90°. Preferentially the angle α amounts to approximately 87°.

With a leading end 12 and trailing end 13 angled-off in this way it is ensured that when a printing plate 10 mounted on a form cylinder is released, the leading end 12 and the trailing end 13 each spontaneously jump out of a mounting channel of the form cylinder and do not jam in the mounting cylinder.

Preferentially the leading end 12 and the trailing end 13 have approximately identical leg lengths. The leg length of leading end 12 and trailing end 13 here is in a range between 3 mm and 12 mm. Such a leg length favors the spontaneous jumping-out of leading end 12 and trailing end 13 from a mounting channel upon releasing of a printing plate mounted on a form cylinder.

The details of a printing plate described above can be similarly transferred to a rubber blanket plate, wherein a rubber blanket plate however is not mountable on a form cylinder of a printing mechanism but rather to a transfer cylinder of a printing mechanism. In this connection it is pointed out that a rubber blanket plate does not carry a print image but rather transfers printing ink applied to the printing plate depending on the subject to a print material to be printed.

A printing plate according to the invention and a rubber blanket plate according to the invention can extend over the entire axial width of a corresponding cylinder, wherein the printing plate width or rubber blanket plate width then corresponds to the utilisable axial extension of the respective cylinder.

Alternatively several printing plates or rubber blanket plates can also be mounted on a cylinder axially next to one another, wherein the printing plate width or rubber blanket plate width then corresponds to an integral divisor of the utilisable width of the respective cylinder.

Likewise a printing plate height or rubber blanket plate height can correspond to the circumference of the respective cylinder or an integral divisor of the circumference of the respective cylinder, in fact dependent on whether seen in circumferential direction of the cylinder exclusively one printing plate or rubber blanket plate or a plurality of printing plates or rubber blanket plates are to be mounted one after the other on the cylinder.

With a printing plate the leading end 12 and the trailing end 13 are each preferentially marked with at least one mark such that to avoid incorrect placing or mounting of the printing plate on a form cylinder the leading end and the trailing end are identifiable.

Here, the, or each, mark can be embodied as a punching or deformation which interacts with a corresponding contouring of the respective cylinder or an automated plate changing device and prevents switching of leading end and trailing end during the mounting of the printing plate on the cylinder.

Via the, or each, mark formed as a punching or deformation it can also be ensured that the printing form can be mounted or placed in register on the form cylinder.

Alternatively the, or each, mark can also be formed as coding applied through exposure or through printing-on wherein the coding can for example be a text, a symbol, or a barcode. A scanning device can then be associated with a cylinder or an automated printing plate changing device with the help of which the coding can be read out from the printing plate in order to prevent in this manner switching of leading end and trailing end during the mounting of a printing plate on a cylinder.

As a further alternative the, or each, mark can also be formed as an RFID-tag that can be read out in a contactless manner, wherein a scanning device for the reading out of the RFID-tag is then associated with the cylinder or the plate changing device.

Printing plates designed according to the invention make possible a plate change on printing units of a printing machine according to FIGS. 2 and 3, wherein FIGS. 2 and 3 each show a schematised printing unit 14 or 15 of a reel-fed rotary printing machine each with four printing mechanisms 16, wherein each printing mechanism has a form cylinder 17 and a transfer cylinder 18. In FIG. 2 the printing unit 14 is embodied as a so-called 8-cylinder printing unit, with which transfer cylinders 18 of neighbouring printing mechanisms 16 roll off on one another and define a printing gap through which a print material 19 can be moved. In FIG. 3 however the printing mechanism 15 is embodied as a so-called 9-cylinder printing unit, in which all transfer cylinders 18 roll off on a satellite cylinder 20 and form printing gaps with the satellite cylinder through which the print material 19 to be printed can be moved.

When using printing plates 10 with symmetrically angled-off leading ends and trailing ends it is possible either to first clamp the leading end or the trailing end in a mounting channel so that a direction of rotation of the cylinders can be optimally selected during mounting and removing of a printing plate.

In addition, all printing plates 10 can be fed to the respective form cylinder 17 in the horizontal feed direction. Without the danger of a geometrical collision with cylinders of other printing mechanisms so-called panorama printing plates can be mounted in the region of the printing mechanism 16 shown on the right side in FIGS. 2 and 3, which in contrast with the printing plates 10 shown on the left side of FIGS. 2 and 3, can extend over the entire circumference of a corresponding form cylinder 17.

### LIST OF REFERENCE NUMBERS

10 Printing plate
11 Main body
12 Leading end
13 Trailing end
14 Printing unit
15 Printing unit
16 Printing mechanism
17 Form cylinder
18 Transfer cylinder
19 Print material
20 Satellite cylinder

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing plate for a printing machine, with a plate-like main body serving as a subject carrier, with a leading end angled-off relative to the main body and with a trailing end angled-off relative to the main body, wherein the printing plate is mountable or placeable on a form cylinder of the printing machine via the leading end and the trailing end and wherein the leading end and the trailing end are symmetrically angled-off relative to the main body such that the leading end and the trailing end enclose an approximately identical angle with a side of the main body, wherein the leading end and the trailing end each enclose an angle between 85° and 90° with the side of the main body.

2. The printing plate according to claim 1, wherein the leading end and the trailing end each enclose an angle of approximately 87° with the side of the main body.

3. The printing plate according to claim 1, wherein the leading end and the trailing end have approximately identical leg lengths.

4. The printing plate according to claim 1, wherein the leading end and the trailing end each have a leg length between 3 mm and 12 mm.

5. The printing plate according to claim 1, wherein the leading end and the trailing end are each marked with a mark such that the leading end and the trailing end are identifiable to avoid incorrect placement on the form cylinder.

6. The printing plate according to claim 5, wherein the mark is formed as a punching or deformation.

7. The printing plate according to claim 5, wherein the mark is formed as a printed or exposed coding

8. The printing plate according to claim 7, wherein the mark is formed as a barcode.

9. The printing plate according to claim 5, wherein the mark is formed as an RFID-tag.

10. A rubber blanket plate for a printing machine, with a plate-like main body, with a leading end angled-off relative to the main body and with a trailing end angled-off relative to the main body, wherein the rubber blanket plate is mountable or placeable on a transfer cylinder of the printing machine via the leading end and the trailing end, and wherein the leading end and the trailing end are angled-off symmetrically relative to the main body such that the leading end and the trailing end enclose an approximately identical angle with a side of the main body, wherein the leading end and the trailing end each enclose an angle between 85° and 90° with the side of the main body.

11. The rubber blanket plate according to claim 10, wherein the leading end and the trailing end each enclose an angle of approximately 87° with the side of the main body.

12. The rubber blanket plate according to claim 10, wherein the leading end and the trailing end have approximately identical leg lengths.

13. The rubber blanket plate according to claim 10, wherein the leading end and the trailing end each have a leg length between 3 mm and 12 mm.

14. A printing machine, comprising:
a plate having a plate-like main body, a first end, and a second end, wherein the first end and the second end each form an angle between 85° and 90° with the main body; and
a cylinder, wherein the first end of the plate and the second end of the plate are disposed in a respective mounting channel defined by the cylinder.

15. The printing machine according to claim 14, wherein the plate is a printing plate and the cylinder is a form cylinder.

16. The printing machine according to claim 14, wherein the plate is a rubber blanket plate and the cylinder is a transfer cylinder.

17. The printing machine according to claim 14, wherein the first end and the second end each form an angle of approximately 87° with the main body.

18. The printing machine according to claim 14, wherein the first end and the second end have an approximately identical leg length.

19. The printing machine according to claim 14, wherein the first end and the second end each have a leg length between 3 mm and 12 mm.

20. The printing machine according to claim 14, wherein the first end and the second end each include a mounting mark.
